(19) United States
(12) Patent Application Publication
(10) Pub. No.: US 2016/0226342 A1
(43) Pub. Date: Aug. 4, 2016

(54) POWER GENERATOR

(71) Applicants: Kazuhiro ONOSE, Hokkaido (JP); HOKKAIDO TOKUSHUSHIRYOU KABUSHIKIKAISHA, Hokkaido (JP)

(72) Inventor: Kazuhiro ONOSE, Hokkaido (JP)

(21) Appl. No.: 14/773,700

(22) PCT Filed: Mar. 7, 2013
(86) PCT No.: PCT/JP2013/056287

§ 371 Date: Dec. 21, 2015

(51) Int. Cl. H02K 7/18; H02K 47/20; H02K 35/02; H02K 7/075

(52) U.S. Cl. CPC H02K 7/1884; H02K 7/1876; H02K 7/075; H02K 47/20; H02K 35/02

(57) ABSTRACT

To propose a new power generator using the movement of a linear magnetic body and to further improve a conventionally-proposed power generator. A configuration is provided including a tubular frame, a freely-moving magnetic body group that is arranged at the inner side of the tubular frame and that is obtained by integrating two or more magnetic bodies while homopolar bodies are opposed to each other, a coil provided on the tubular frame to have an interval to the outer periphery of the freely-moving magnetic body group and that is configured to alternately have a reversed winding direction, and an output line for outputting electric power from the coil. In a configuration in which the freely-moving magnetic body groups slide relative to each other in a coil axial direction to generate power, a transmission means is provided that is coupled to at least any one tip end of the freely-moving magnetic body group in a substantial axial direction, and power is generated in accordance with the movement of the transmission means.

### TECHNICAL FIELD

The present invention relates to a power generator in which power generation is performed by sliding a magnetic body in a coil. In particular, the invention relates to a power generator characterized by a transmission method for transmission to the magnetic body.

### BACKGROUND ART

Conventionally, a mechanism has been known in which power is generated by reciprocatingly moving a magnetic body. According to a linear vibration electric machine disclosed in Patent Publication 1, providing permanent magnets at one end side and the other end side to sandwich a non-magnetic spacer in a dislocation direction of a movable core is proposed. This can suppress a large number of magnetic fluxes from being closed in the movable core meaning that many magnetic fluxes can be transmitted between a teeth section and the movable core. Thus, when the linear vibration electric machine is used as an actuator, a magnetic attractive force generated between the teeth section and the movable core can be increased. Therefore, thrust generated in the movable core can be increased, thereby improving the actuation efficiency of the actuator.

According to a vibration electricity generator disclosed in Patent Publication 2, homopolar permanent magnets are opposed to have a minute distance therebetween, a plurality of magnetized permanent magnets are integrated in a plurality of length directions, and a change in the magnetic flux distribution is made to be steeper. The plurality of permanent magnets is integrated so that the magnetic flux direction is made to be approximately a right angle in a coil winding direction and the magnetic flues are locally arranged with a high density. The outer periphery of the plurality of permanent magnets has a plurality of serially-arranged coils. The coils have an appropriate interval and are constituted to alternately have a reversed winding direction. By moving the integrated permanent magnets, power is generated.

The vibration electricity generator disclosed in Patent Publication 3 includes a case that is formed to have a tube-like shape and that consists of a non-magnetic body; a coil wound around the outer periphery of the case; a plurality of movable magnets that are magnetized in the length direction of the case and that are formed to have a tube-like shape and are disposed so as to be movable and oppose homopolar magnets in the case, and tightening members that are inserted to hole sections of the plurality of magnets and that integrate the plurality of magnets. This configuration realizes reduced load for power generation and high output and high efficiency by which a high voltage is generated.

In addition, Patent Publications 4 and 5 are disclosed as a technique to generate power by opposed homopolar magnets.

### PRIOR ART PUBLICATION

### Patent Publication

Patent Publication 1: Japanese Patent No. 3818243

Patent Publication 2: Japanese Patent No. 4704093

Patent Publication 3: Japanese Unexamined Patent Application Publication No. 2011-050245

Patent Publication 4: International Patent Publication No. W02004/093290

Patent Publication 5: International Patent Publication No. W02005/031952

### SUMMARY OF THE INVENTION

### Problem to be Solved by the Invention

The above conventional techniques have suggested various power generation methods by the linear sliding of a magnetic body. However, how to apply a reciprocating vibratory motion to a magnetic body in order to move the magnetic body has been discussed insufficiently. For example, Patent Publication 1 discloses a thermoacoustic engine as “some means”. Patent Publication 2 discloses that power is generated by the vibration or impact for example caused by being carried by a person.

The present invention has been made in view of the disadvantages of the above conventional techniques. It is an object of the invention to provide a new power generator using the movement of a linear magnetic body and to further improve a conventionally-proposed power generator.

### Means for Solving the Problem

In order to solve the above disadvantages, the present invention uses the following means.

According to the invention of claim 1, a power generator is provided that includes a tubular frame; a freely-moving magnetic body group that is provided at an inner side of the tubular frame and that is obtained by integrating two or more magnetic bodies so that homopolar bodies are opposed to each other; a coil that is provided on the tubular frame to have an interval to the outer periphery of the freely-moving magnetic body group and that is configured to alternately have a reversed winding direction; and an output line for outputting electric power from the coil. The freely-moving magnetic body groups slide relative to each other in the coil axial direction to thereby generate power. This configuration is characterized in that a transmission means is connected to at least any one tip end of the freely-moving magnetic body group in a substantial axial direction and power is generated in accordance with the movement of the transmission means.

According to the invention of claim 2, the power generator may be configured to include an end magnetic body that is provided so that a magnetic pole of at least any one tip end of the freely-moving magnetic body group and a homopolar magnetic pole are opposed to each other.

According to the invention of claim 3, in the power generator, the transmission means may be substituted with a configuration obtained by inclining at least a part of the tubular frame to move the freely-moving magnetic body group by gravity force to thereby generate power.

According to the invention of claim 4, the power generator may be configured to include a lifting means to lift the freely-moving magnetic body group from a low position to a high position of the tubular frame.

According to the invention of claim 5, the power generator may use a biasing means for biasing the freely-moving magnetic body group by the transmission means or an external force instead of the transmission means. The freely-moving magnetic body group is allowed to freely move along the inner side of the tubular frame. A part of the tubular frame is configured to have a loop-like section. Power is generated while allowing the freely-moving magnetic body group to circulate in the loop-like section.

According to the invention of claim 6, a configuration may be used in which a plurality of the floating magnetic body groups are provided and the floating magnetic body groups are coupled to have a predetermined interval to one another to cooperate.

According to the invention of claim 7, a configuration may be used in which the plurality of the floating magnetic body groups are provided and the floating magnetic body groups cooperate while the floating magnetic body groups are positioned by repulsion force of neighboring homopolar bodies in an axial direction to have a predetermined interval to one another.

According to the invention of claim 8, a configuration may be used in which the transmission means includes a motion conversion mechanism for converting the reciprocating motion of the freely-moving magnetic body group in a substantial axial direction to a rotating motion, and inputs a rotating motion from a gear or turbine axis.

The invention of claim 9 is characterized in that the transmission means of the power generator is connected to a displacer piston of a stirling engine and an output from a power piston is obtained simultaneously with power generation.

The invention of claim 10 is characterized in that the transmission means of the power generator is connected to the power piston of the stirling engine and an output of the stirling engine is used for power generation.

According to the invention of claim 11, the plurality of power generators may be used to couple the transmission means to one another.

According to the invention of claim 12, a configuration may be used in which transmission means are provided that are coupled to both tip ends of the freely-moving magnetic body group in a substantial axial direction. One transmission means is coupled to a power source. The other transmission means functions to follow the one transmission means to outwardly transmit the input of the power source. Power generation is performed during the power transmission.

The invention of claim 13 is characterized in that, in the stirling engine using the power generator according to claim 1 or 2, the tubular frame of the power generator is a cylinder. The freely-moving magnetic body group is allowed to slide as a displacer piston. An output from the power piston is obtained simultaneously with power generation.

The invention of claim 14 is characterized in that, in the stirling engine using the power generator according to claim 1 or 2, the tubular frame of the power generator is a cylinder. The freely-moving magnetic body group is allowed to slide as a power piston. An output from the power piston is obtained simultaneously with power generation.

According to the invention of claim 15, the power generator may be provided in a low temperature-side environment in a heat pump mechanism so that power generation is performed while cooling the power generator.

The transmission means may include a flywheel for converting the reciprocating motion of the freely-moving magnetic body group in a substantial axial direction to a rotating motion. A circumference of the flywheel and a position opposed to the circumference have electromagnets and permanent magnets. The rotation of the flywheel can be biased by converting the polarities of the electromagnets in accordance with the rotation of the flywheel.

### Effect of the Invention

According to the present invention, by providing a transmission means coupled to at least any one tip end of the freely-moving magnetic body group in a substantial axial direction, power of various energy sources can be transmitted to the freely-moving magnetic body group, thus realizing improved energy efficiency of an introduced system and diversified power generation methods.

### BRIEF DESCRIPTION OF THE DRAWINGS

FIG. 1 illustrates a first embodiment of a power generator of the present invention.

FIG. 2 illustrates a second embodiment of the power generator of the present invention.

FIG. 3 illustrates a third embodiment using an epicyclic gear mechanism as an example of transmission means.

FIG. 4 illustrates a fourth embodiment using a crank as an example of transmission means.

FIG. 5 illustrates a fifth embodiment of the power generator of the present invention.

FIG. 6 illustrates a system example using the power generator of the present invention.

FIG. 7 is an explanatory diagram illustrating a stirling engine.

FIG. 8 is a schematic view illustrating a system obtained by combining the stirling engine with this power generator.

FIG. 9 is a schematic view illustrating a power generation system using gravity force.

FIG. 10 is a schematic view illustrating another embodiment.

FIG. 11 illustrates an example in which a displacer piston is configured by a structure of a freely-moving magnetic body group according to the present invention.

FIG. 12 illustrates an embodiment in which the transmission means includes a flywheel.

### DESCRIPTION OF EMBODIMENTS

The following section will describe an example of a power generator according to the present invention with reference to the drawings. It is noted that the present invention can be appropriately changed within the scope of the claims and is not limited to this embodiment.

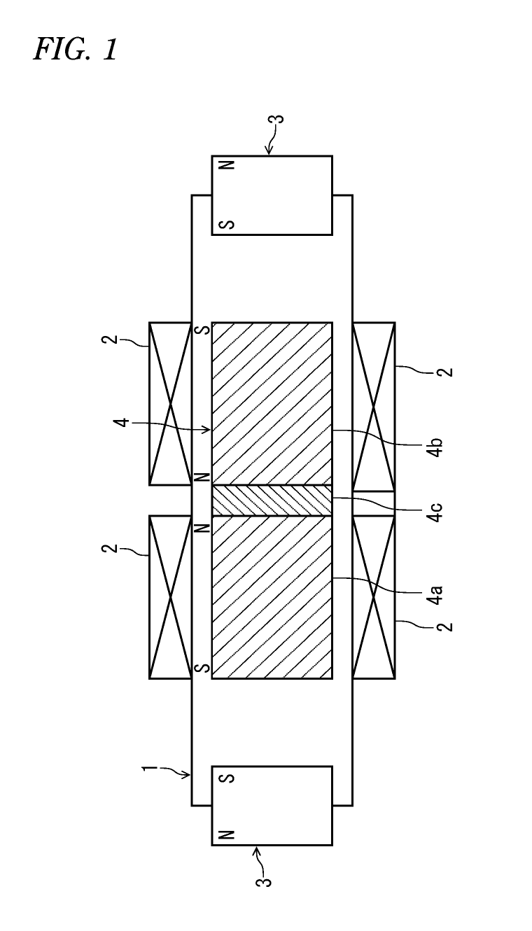

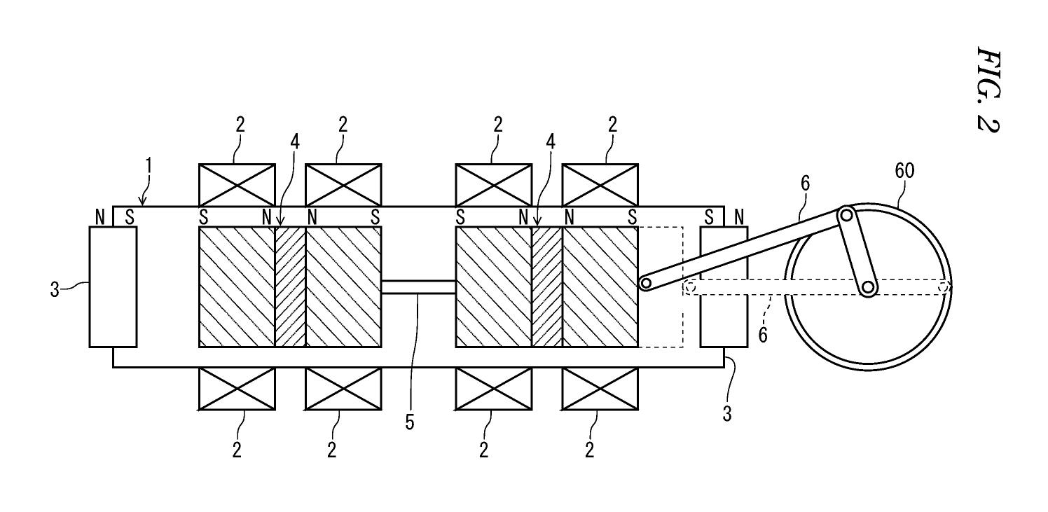

FIG. 1 illustrates a first embodiment of the present invention. A tubular frame (1) and a freely-moving magnetic body group (4) are provided. The freely-moving magnetic body group (4) is provided at an inner side of the tubular frame (1) and is obtained by integrating two magnets (4a) and (4b) so that homopolar magnets are opposed to each other to sandwich a spacer (4c). In the drawing, one freely-moving magnetic body group (4) is shown. However, the present invention also can use a plurality of freely-moving magnetic body groups (4) as in an embodiment which will be described later.

On the tubular frame (1), coils (2) are provided that are configured to alternately have a reversed winding direction at a position having an interval to the outer periphery of the freely-moving magnetic body group (4). In conventional techniques, providing a plurality of coils to have an interval corresponding to an interval among the respective magnets has been suggested. A similar arrangement is also used in this embodiment. A method of arranging coils is not limited to this embodiment and an appropriate arrangement having high power generation efficiency can be employed.

Although not shown, the respective coils (2) are connected to each other and an output line for outputting electric power is provided. When the freely-moving magnetic body groups (4) slide relative to one another in the axial direction of the coils (2), electromotive force is generated in the coils (2) and is outputted from the output line to thereby act as a power generator.

The present invention suggests newly providing permanent magnets (3) and (3) at ends of the tubular frame (1). The permanent magnets are arranged so that those homopolar to the polarities of the tip ends of the freely-moving magnetic body group (4) are opposed to each other. In the drawing, the south pole of the permanent magnet (3) is opposed to the south pole of the left end of the magnet (4a) and the right end of the magnet (4b).

According to this configuration, the south poles opposed to each other can form a magnetic force line as in the case where homopolar poles in the freely-moving magnetic body group (4) are opposed to each other, thereby providing improved power generation efficiency. Furthermore, when an external force is applied to the tubular frame (1) to slide the freely-moving magnetic body group (4), the repulsion force caused by homopolar poles against each other can prevent the freely-moving magnetic body group (4) from colliding with the tubular frame (1).

Regarding this point, Patent Publication 3 has a buffer member for the purpose of buffering collision. According to the present invention, the use of the permanent magnet provides a substitute means for buffering and also improves power generation efficiency.

FIG. 2 illustrates a second embodiment including, in addition to the configuration of FIG. 1, a transmission means as a feature of the present invention and two freely-moving magnetic body groups.

As in the above case, the outer periphery of the tubular frame (1) has a plurality of coils (2) and the ends thereof have permanent magnets (3). The tubular frame (1) includes therein two freely-moving magnetic body groups (4) coupled by a coupling member (5).

A tip end of the right-side freely-moving magnetic body (4) has a transmission rod (6) that is coupled in a substantial axial direction. The transmission rod (6) protrudes outward through a penetration hole provided at the center of the permanent magnet and rotates a flywheel (60) by a known crank mechanism. Specifically, the two freely-moving magnetic body groups (4) cooperate to slide within the tubular frame (1) so that the flywheel (60) rotates one revolution while the two freely-moving magnetic body groups (4) reciprocate one time between the top dead point and the bottom dead point.

According to the present invention, by vibrating the tubular frame (1) itself, in contrast with the conventional vibration electricity generator, the rotating motion can be used to generate power using this electricity generator, thus contributing to diversified power generation methods.

The flywheel (60) can also be rotated by an arbitrary gear mechanism or can be rotated by being connected to a turbine mechanism. Another configuration may also be used in which the flywheel (60) is provided in a rotation axis connecting a turbine and an electricity generator so that the power generation by the electricity generator of the present invention can be carried out in addition to conventional power generation. This configuration can realize maximum energy use even when the turbine has a redundant force.

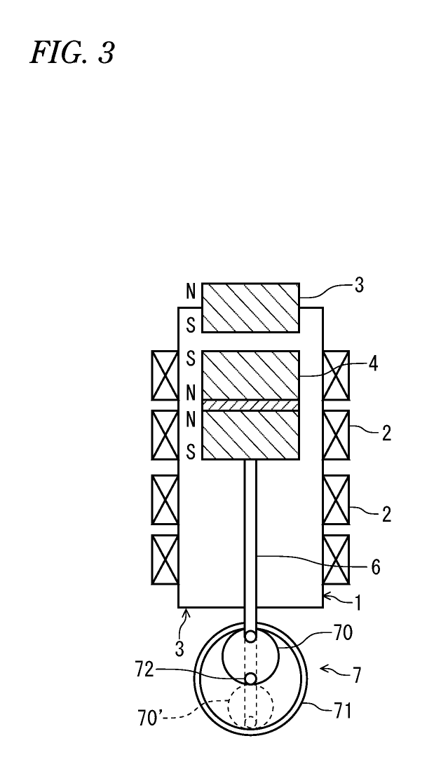

FIG. 3 illustrates a third embodiment of a transmission means in which an end of the transmission rod (6) is coupled to an epicyclic gear mechanism (7). The epicyclic gear mechanism (7) is composed of an epicyclic gear (70) and a sun internal gear (71). The epicyclic gear (70) revolves around the inner circumference while being engaged with the sun internal gear (71) and the epicyclic gear (70) rotates to thereby reciprocatingly move the rod (6) without inclination. By rotating the epicyclic gear (70) by a center gear (70), the rotation can be converted to a reciprocating motion. Thus, this embodiment features a mechanism favorable for moving this power generator using rotating motion.

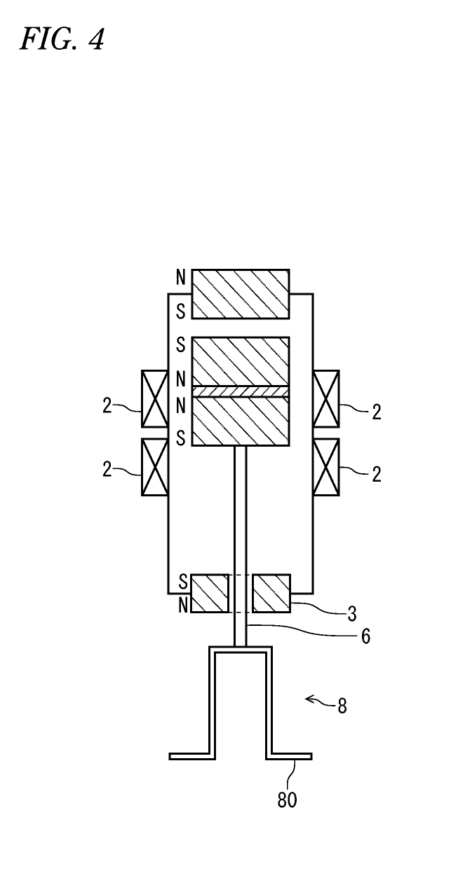

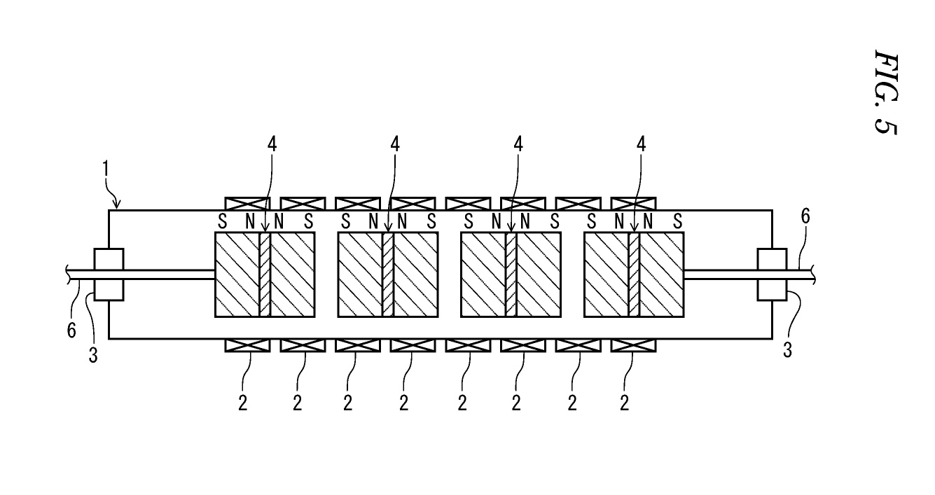

FIG. 4 illustrates a fourth embodiment in which an end of the transmission rod (6) is coupled to a crank (8). By allowing a crank section (81) to rotate around the rotation axis (80), the rotating motion of the rotation axis (80) is converted to the reciprocating motion of the transmission rod (6).

A motion conversion mechanism according to the present invention may appropriately include a crank mechanism combined with a flywheel as described above, an epicyclic gear mechanism, a mechanism using a crank, and mechanisms using known mechanical elements.

FIG. 5 illustrates a fifth embodiment showing an example in which a predetermined interval is retained, without using a coupling member (5), by the magnet repulsion forces between the freely-moving magnetic bodies (4) against each other.

As can be seen from the drawing, the respective freely-moving magnetic bodies (4) are arranged so that neighboring homopolar freely-moving magnetic bodies are opposed to each other. The repulsion force among the freely-moving magnetic bodies (4) allows the freely-moving magnetic bodies (4) to be naturally positioned to have an interval thereamong within the tubular frame (1) providing a closed space.

The elimination of the use of the coupling member (5) provides a lighter weight to reduce the energy required to slide the freely-moving magnetic bodies (4), thus improving power generation efficiency.

The example of FIG. 5 is also different from other embodiments in that the transmission rods (6) are protruded at both of the left and right sides. Thus, according to the present invention, the transmission means may be provided not only at one end but also at both ends.

When the transmission rods (6) are protruded at both ends, two different embodiments having different functions may be considered. The first embodiment is a configuration in which both transmission rods (6) are moved in a synchronized manner and input external forces. In this case, a large force is applied to the freely-moving magnetic bodies (4) and the synchronized motions applied from both sides contribute to the stability of the reciprocating motion.

The second embodiment is a configuration in which one transmission rod (6) inputs an external force (power piston) and the other transmission rod (6) is driven by the reciprocating motion via the respective freely-moving magnetic bodies (4) (displacer piston). According to this configuration, this power generator is introduced into a mechanism for converting a rotating motion to a reciprocating motion. The driving side uses the motion conversion mechanism to convert the rotating motion to the reciprocating motion. Thereafter, the driven side can use the reciprocating motion as a power source for another apparatus.

The rotating motion also can be converted again by the driven side.

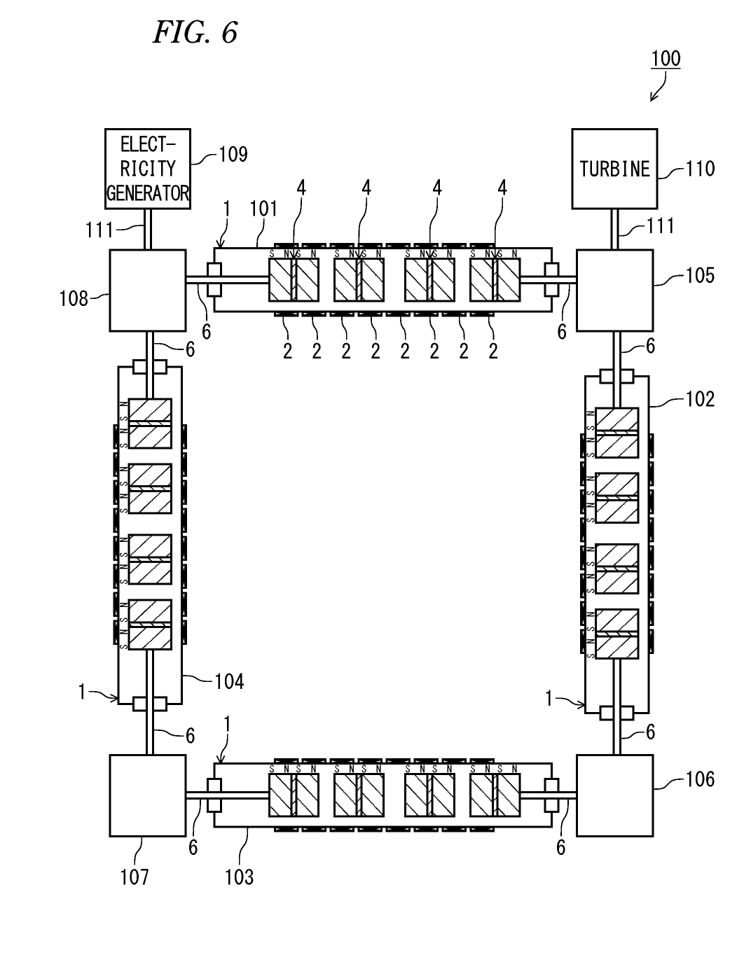

FIG. 6 illustrates a system example using a plurality of power generators of the present invention.

In this system (100), transmission rods (6) and (6) from four power generators (101), (102), (103), and (104) are coupled by motion conversion mechanisms (105), (106), (107), and (108) to thereby allow a plurality of power generators to cooperate. By coupling the power generators in a loop-like manner, sliding that is more stable than in the case of a simple parallel connection can be achieved.

The motion conversion mechanism also can be coupled to the electricity generator (109) or the turbine (110) via a transmission axis (111). In addition to the configuration as shown in the drawing in which one of the electricity generators (109) or the turbine (110) is connected to one motion conversion mechanism, other configurations may also be used in which a motion conversion mechanism receives an input on the same axis as that of an electricity generator operated by a turbine, or all motion conversion mechanisms are coupled to the electricity generator or the turbine.

As described above, the power generator of the present invention can also be used as a transmission mechanism, thus contributing to diversified applications.

The turbine (110) may be combined with a known power generation method to generate power using heat energy by a burning apparatus. The turbine (110) can also be combined with an electricity generator for hydraulic power generation for rotating a turbine by the hydraulic power from a river, for example.

### Another Embodiment 1

The power generator of the present invention is preferably combined with a stirling engine because the power generator can generate power by a relatively-small force by a reciprocating motion.

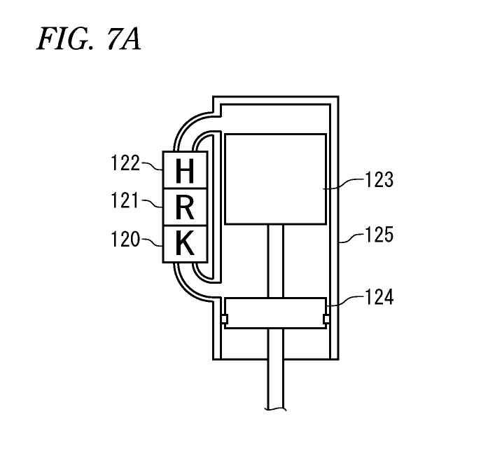

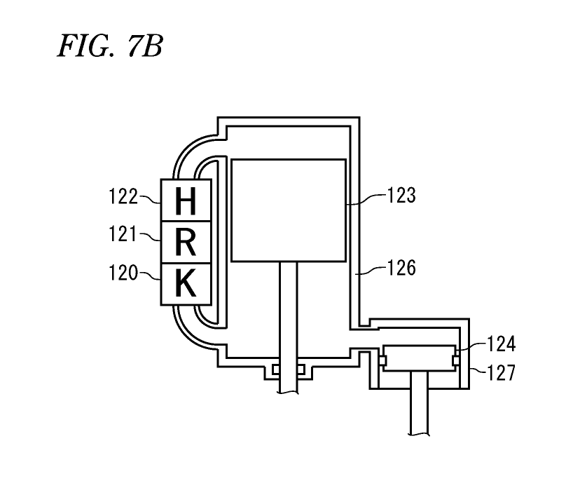

First, the stirling engine will be briefly described. FIGS. 7A and 7B illustrate two embodiments of a general stirling engine. As is known, a stirling engine is configured so that a piston moves within a cylinder in a heat cycle process called a stirling cycle composed of equal heating, isothermal expansion, equal cooling, and isothermal compression.

In the engine of FIG. 7A, a displacer piston (123) and a power piston (124) are arranged to separately move on the same axis in one cylinder (125). The upper side of the displacer piston functions as an expansion space while the lower space sandwiched between the displacer piston (123) and the power piston (124) functions as a compression space.

The engine of FIG. 7B is a two-cylinder-type (126) and (127) engine. The displacer piston (123) and the power piston (124) are connected by a crank having a phase difference of 90 degrees.

The present invention may be combined with any type of engine. However, the two-cylinder-type engine shown in FIG. 7B is commonly used. Thus, this embodiment shows an example using the two-cylinder-type engine.

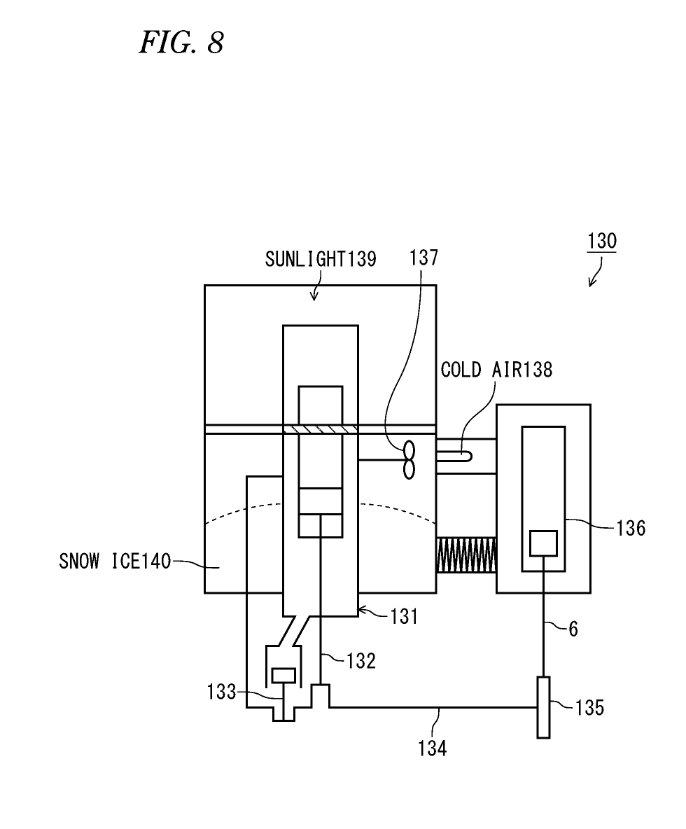

FIG. 8 illustrates a system (130) obtained by combining the stirling engine (131) with this electricity generator (136). The rotating motion of the crank (134) coupling the displacer piston (132) to the power piston (133) is inputted to the electricity generator (136) using the flywheel (135) and the transmission rod (6) to generate power.

Regarding the operation of the stirling engine, the heating and cooling may be carried out using any energy source. For example, a hot-cold space may be configured in which the lower part is cooled by snow ice (140) for example while the upper part is heated by sunlight (139) for example so that a temperature difference therebetween can be used for driving. In a cold area, a large amount of snow ice can be used to easily create a low temperature environment with a smaller cost and the high temperature side is provided using solar heat, thereby securing the power by the stirling engine.

The present invention intends to use this combination with the stirling engine to thereby also perform power generation simultaneously.

In the above embodiment, a configuration is used in which the displacer piston cooperates with the power piston. However, another configuration may be used in which any one the pistons is coupled.

Alternatively, the low temperature-side space may include a fan (137) to cool the electricity generator (136). The power generator uses many coils and so it is of concern that the heat generated from a coil during power generation and the resultant power generation efficiency may be decreased. As described above, since the stirling engine has a low temperature-side environment, cooling is performed using the low temperature-side environment, thus contributing to power generation having higher efficiency. The stirling engine can also prevent a member such as a coil from being deteriorated due to a continued high temperature status.

From the viewpoint of cooling the coil, this power generator may also be provided in a low temperature-side environment in a heat pump mechanism so that power can be generated while cooling the power generator. As is well known, the stirling engine and the heat pump are mechanisms using converse phenomena and are mutually affinitive. When the heat pump mechanism is used, the heat from either the high temperature-side or the low temperature-side is often not used. Thus, the low temperature-side environment in particular can be used to cool the coil of this power generator. This configuration also contributes to power generation having higher efficiency.

### Another Embodiment 2

According to the present invention, power can also be generated by a configuration in which at least a part of the tubular frame (1) is inclined as a substitute for the transmission means so that the freely-moving magnetic body group (4) is dropped by gravity force.

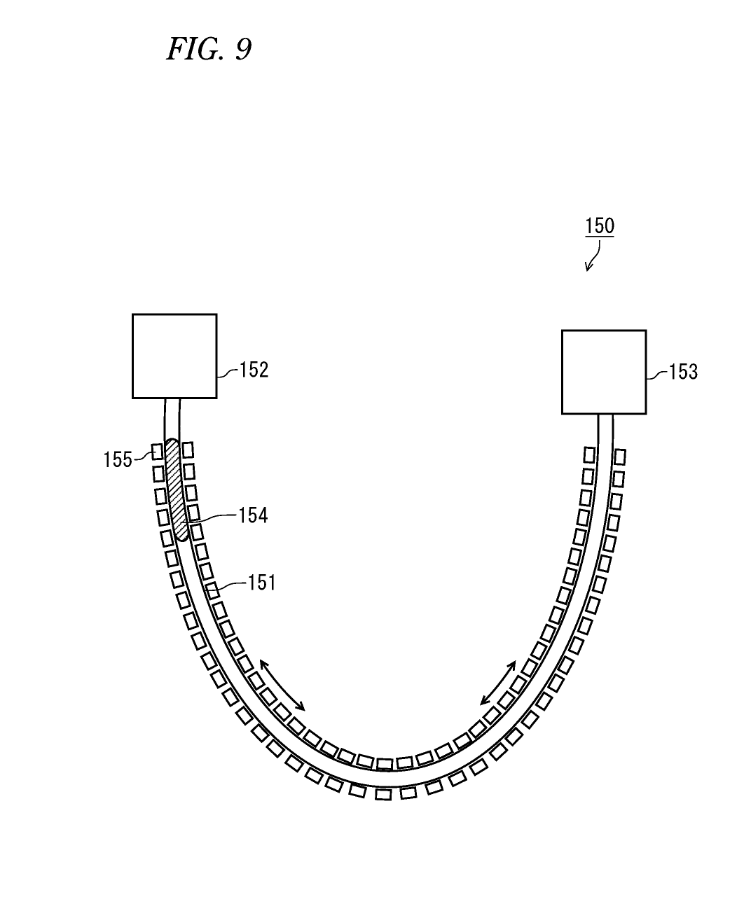

FIG. 9 illustrates one example of a power generation system (150) using gravity force. A tubular frame (151) is configured by a large U-shaped pipe line and its upper end has assist apparatuses (152) and (153). The tubular frame (151) has many coils (155) as in the above embodiment. Power is generated by allowing a freely-moving magnetic body group (154) to reciprocate within the pipe line.

The freely-moving magnetic body group (154) drops from the upper side to the lower side by gravity force but cannot be raised to the other upper end in that state. Thus, the assist apparatuses (152) and (153) are used to bias the freely-moving magnetic body group (154) so that the freely-moving magnetic body group (154) can reach the upper end.

Needless to say, the assist apparatuses (152) and (153) operate by natural energy such as wind or hydraulic power and can continuously provide power generation by the motion of the freely-moving magnetic body group (154).

### Another Embodiment 3

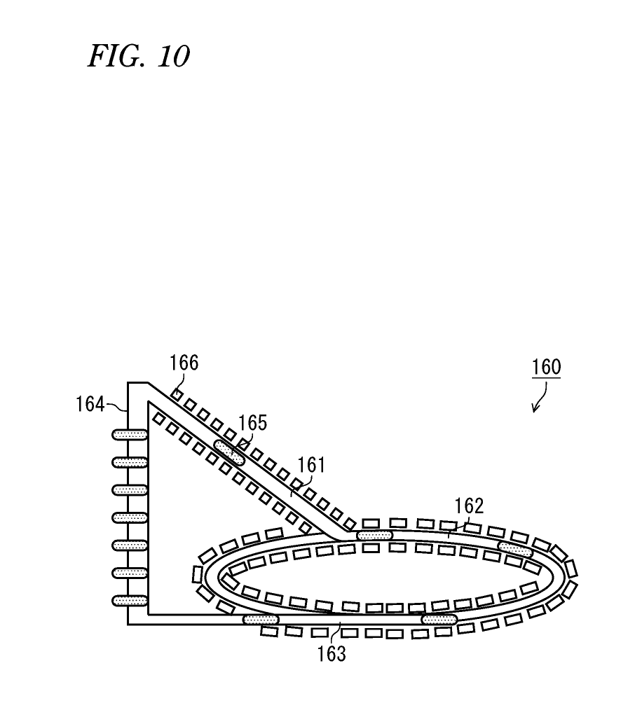

FIG. 10 illustrates a configuration in which the freely-moving magnetic body group (4) is moved by similarly using gravity force. The tubular frame in this system (160) is composed at least of a drop inclined section (161), a loop section (162), a return conveyance section (163), and a lifting section (164).

The freely-moving magnetic body group (165) is biased by being allowed to drop within the drop inclined section (161) to revolve around the loop section (162). The drop inclined section (161) and the loop section (162) have a coil (166) and thus continuously provide power generation during revolving.

The loop section (162) includes a separation mechanism (not shown) to separate the freely-moving magnetic body group (165) having a fixed speed or less within the loop section (162). The separated freely-moving magnetic body group (165) is moved via the return conveyance section (163) and is lifted again by the lifting section (165) to reach the upper end of the drop inclined section (161).

The lifting section (165) can be similarly lifted by natural energy such as a water wheel-like mechanism to continuously provide power generation.

### Another Embodiment 4

According to the present invention, the feature of the power generator can be applied to the cylinder and piston themselves of the stirling engine.

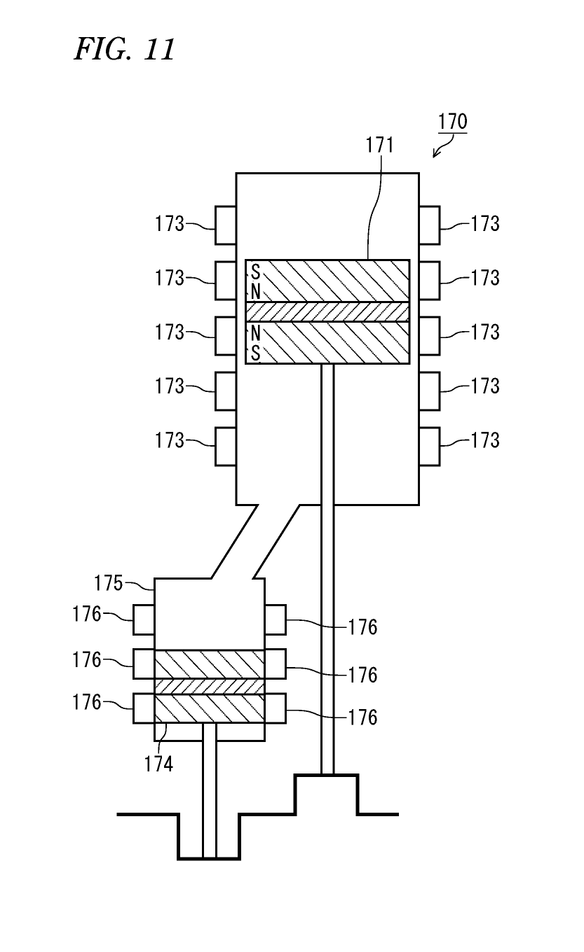

Specifically, as shown in FIG. 11, the displacer piston (171) of the stirling engine (170) is configured by the structure of the freely-moving magnetic body group according to the present invention and the outer periphery of the cylinder (172) has a plurality of coils (173).

According to this configuration, in accordance with the reciprocating motion of the displacer piston (171) of the stirling engine, the effect of power generation by this power generator can be obtained.

Furthermore, the power piston (174) can also be configured by the structure of the freely-moving magnetic body group and the outer periphery of the cylinder (175) has a plurality of coils (176) so that the power piston (174) side can also provide power generation.

The stirling engine is characterized by the reciprocating motion using two pistons and provides a synergetic advantage together with the power generator using the reciprocating motion of the present invention.

### Another Embodiment 5

In the power generator of the present invention, the transmission means may include a flywheel for converting the reciprocating motion of the freely-moving magnetic body group in a substantial axial direction to a rotating motion. A circumference of the flywheel and a position opposed to the circumference have an electromagnet and a permanent magnet. In accordance with the rotation of the flywheel, the polarities of the electromagnets may be converted to thereby bias the rotation of the flywheel.

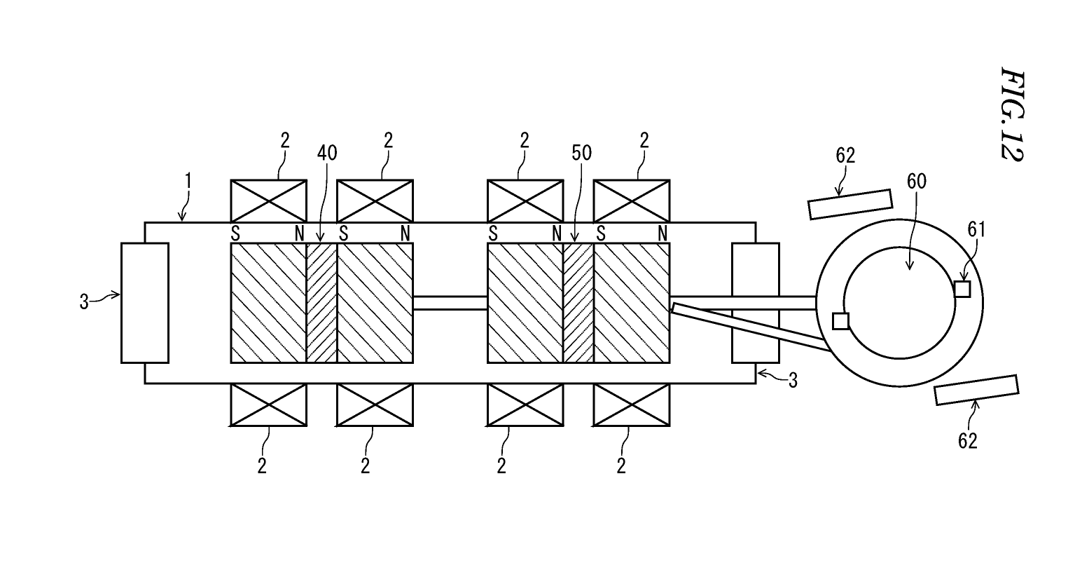

As shown in FIG. 12, the transmission rod (6) is coupled to the flywheel (60) on which the electromagnet (61) is provided whose polarity is inverted in accordance with the rotation of the flywheel (60). The outer periphery of the flywheel has a permanent magnet (62). According to this configuration, the magnetic force by the electromagnet and the permanent magnet can act to continuously rotate the flywheel, thus assisting the reciprocating motion of the piston.

### REFERENCE MARKS IN THE DRAWINGS

1 Tubular frame

2 Power generation coil

3 Magnet

4 Freely-moving magnetic body group

4a Magnet

4b Magnet

4c Spacer

1. A power generator, characterized in comprising:
a tubular frame;
a freely-moving magnetic body group that is arranged at an inner side of the tubular frame and that is obtained by integrating two or more magnetic bodies while homopolar bodies are opposed to each other;
a coil that is provided on the tubular frame to have an interval to an outer periphery of the freely-moving magnetic body group and that is configured to alternately have a reversed winding direction; and
an output line for outputting electric power from the coil, wherein:
in a configuration in which the freely-moving magnetic body groups slide relative to each other in a coil axial direction to thereby generate power,
a transmission means is provided that is coupled to at least any one tip end of the freely-moving magnetic body group in a substantial axial direction, and
power is generated in accordance with movement of the transmission means.

2. The power generator according to claim 1, comprising:
an end magnetic body that is provided so that a magnetic pole of at least any one tip end of the freely-moving magnetic body group and a homopolar magnetic pole are opposed to each other.

3. The power generator according to claim 1, wherein:
the transmission means is substituted with a configuration obtained by inclining at least a part of the tubular frame to move the freely-moving magnetic body group by gravity force to thereby generate power.

4. The power generator according to claim 3, wherein:
the power generator is configured to include a lifting means to lift the freely-moving magnetic body group from a low position to a high position of the tubular frame.

5. The power generator according to claim 1, wherein:
the power generator uses a biasing means for biasing the freely-moving magnetic body group by the transmission means or an external force instead of the transmission means, the freely-moving magnetic body group is allowed to freely move along the inner side of the tubular frame, a part of the tubular frame is configured to have a loop-like section, and power is generated while allowing the freely-moving magnetic body group to circulate in the loop-like section.

6. The power generator according to claim 1, wherein:
a configuration is used in which a plurality of the floating magnetic body groups are provided and the floating magnetic body groups are coupled to have a predetermined interval to one another to cooperate.

7. The power generator according to claim 1, wherein:
a configuration is used in which the plurality of the floating magnetic body groups are provided and the floating magnetic body groups cooperate while the floating magnetic body groups are positioned by repulsion force of neighboring homopolar bodies in an axial direction to have a predetermined interval to one another.

8. The power generator according to claim 1, wherein:
the transmission means comprises a motion conversion mechanism for converting the reciprocating motion of the freely-moving magnetic body group in a substantial axial direction to a rotating motion and for inputting a rotating motion from a gear or a turbine axis.

9. The power generator according to claim 1, wherein:
the transmission means of the power generator is connected to a displacer piston of a stirling engine and an output from a power piston is obtained simultaneously with power generation.

10. The power generator according to claim 1, wherein the transmission means of the power generator is connected to the power piston of the stirling engine and an output of the stirling engine is used for power generation.

11. The power generator according to claim 1, wherein a plurality of power generators may be used to couple the transmission means to one another.

12. The power generator according to claim 1, wherein:
transmission means are provided that are coupled to both tip ends of the freely-moving magnetic body group in a substantial axial direction, one transmission means is coupled to a power source, another transmission means functions to follow the one transmission means to outwardly transmit an input of the power source, and power generation is performed during the power transmission.

13. A stirling engine using the power generator according to claim 1, wherein:
the tubular frame of the power generator is a cylinder, the freely-moving magnetic body group is allowed to slide as a displacer piston, and
an output from the power piston is obtained simultaneously with power generation.

14. A stirling engine using the power generator according to claim 1, wherein:
the tubular frame of the power generator is a cylinder, the freely-moving magnetic body group is allowed to slide as a power piston, and
an output from the power piston is obtained simultaneously with power generation.

15. The power generator according to claim 1, wherein:
the power generator is provided in a low temperature-side environment in a heat pump mechanism so that power generation is performed while cooling the power generator.

16. The power generator according to claim 1, wherein:
the transmission means includes a flywheel for converting the reciprocating motion of the freely-moving magnetic body group in a substantial axial direction to a rotating motion, a circumference of the flywheel and a position opposed to the circumference have electromagnets and permanent magnets, and the rotation of the flywheel is biased by converting the polarities of the electromagnets in accordance with the rotation of the flywheel.
